(19) United States
(12) Patent Application Publication
(10) Pub. No.: US 2020/0263718 A1
(43) Pub. Date: Aug. 20, 2020

(54) PROBE SOCKET FOR AN EXHAUST SYSTEM

(71) Applicant: Eberspächer Exhaust Technology GmbH, Neunkirchen (DE)

(72) Inventor: Dieter ACKERMANN, Esslingen (DE)

(21) Appl. No.: 16/793,801

(22) Filed: Feb. 18, 2020

(30) Foreign Application Priority Data
Feb. 20, 2019 (DE) 10 2019 001 246.1

(51) Int. Cl. F16B 5/08; F01N 13/18; B23K 9/02

(52) U.S. Cl. CPC F16B 5/08; B23K 9/02; F01N 13/1805

(57) ABSTRACT

An exhaust system probe socket has an essentially hollow cylindrically configured first body, which has a planar circular ring surface on a first end face and a second body with a flat circular ring surface at a first end. The second body has a passage with a diameter that corresponds to or is greater than an internal diameter of the first body. A second end of the second body is configured to make possible a gastight connection of the probe socket to a connection surface by compensating geometric deviations of the connection surface from a plane. The first and second bodies contact one another in an area of a second end face of the first body and of the flat circular ring surface and are welded to one another with a weld seam extending circumferentially around the first body to gastightly connect the bodies to one another.

### CROSS REFERENCE TO RELATED APPLICATIONS

This application claims the benefit of priority under 35 U.S.C. § 119 of German Application 10 2019 001 246.1, filed Feb. 20, 2019, the entire contents of which are incorporated herein by reference.

### TECHNICAL FIELD

The present invention pertains to a probe socket for mounting measuring probes, for example, lambda probes, at an exhaust system. Openings are made for this purpose in the housing of the exhaust system and the sockets are inserted into the openings and welded to the housing such that the housing is again closed in an airtight manner. The sockets have, as a rule, an internal thread, into which the particular probe can be screwed. A planar sealing surface is provided on the end face of the socket, which end face is located on the outside. When screwing the probe into the thread, a sealing surface of the probe is pressed onto the sealing surface of the socket in order to guarantee a gastight closure of the opening.

### TECHNICAL BACKGROUND

In terms of their geometry, exhaust systems are adapted basically to the particular vehicle, into which they shall be installed. The space available in the engine compartment and in the area of the underbody is generally very limited, so that the exhaust systems must be configured in a complicated manner to fit the available space.

It is difficult to accommodate especially components that project from the exhaust system, such as the measuring probes mentioned in the introduction. Therefore, there is not enough space available to use a standard socket, which would meet all conditions. A separate socket is necessary for this reason for each vehicle type.

In addition, the sockets are frequently not welded to flat components, but to free forms, which, as a rule, make manufacture as a forged or cast part necessary. These forged or cast parts must then be machined in an additional working step in order to prepare the thread and the planar surfaces. As a consequence, the manufacture of the probe sockets is very expensive.

Furthermore, the requirements imposed on the dimensional stability of the sealing surfaces and the strength of the thread are high. On the one hand, the tightness must be guaranteed and, on the other hand, replacement of the probes may be necessary during the service life of a catalytic converter device. However, tearing out the thread during the replacement of the probe could make it necessary to replace the complete catalytic converter housing.

For example, a probe socket, which is manufactured completely as a deep-drawn part from sheet metal, is known from EP 2 270 320 A2. A probe socket can be manufactured at a favorable cost in this manner, but the above-mentioned requirements on the tightness and the strength are not guaranteed in each case.

### SUMMARY

An object of the present invention is to provide a standard socket, which can be manufactured in a simple and favorable manner and nevertheless guarantees good tightness and high strength and service life of the thread.

The present invention is based on the general idea of manufacturing the probe socket as a standard component with a simple geometry from a suitable material, for example, steel, and to connect it via an additional component, which is adapted to the particular exhaust system, to this exhaust system. The socket proper can thus be manufactured as a hollow cylinder, for example, as a turned part from steel for all vehicle types in a large quantity in a favorable manner. The other component may also be manufactured, for example, as a forged part or as a sintered part likewise in a more favorable manner, because no thread needs to be cut anymore in the component. Probe sockets that can be adapted to all types of exhaust systems and are nevertheless ultimately more favorable than pure forged or cast parts can thus be manufactured by the combination of two components, which can be manufactured in a favorable manner.

Corresponding to an especially advantageous embodiment, the probe socket for an exhaust system has a first body having an essentially hollow cylindrical configuration, which has on a first end face a first planar circular ring surface, wherein the probe socket has a second body, which has a flat circular ring surface at a first end and within the flat circular ring surface it has a passage, whose diameter corresponds to or is greater than the internal diameter of the first body. A second end of the second body is configured such that it makes possible a gastight connection of the probe socket to a connection surface by compensating geometric deviations of the connection surface from a plane, wherein the first and second bodies are in contact with one another in the area of a second end face of the first body and of the flat circular ring surface and are welded to one another with a weld seam extending around the first body such that the bodies are connected to one another in a gastight manner.

According to an advantageous variant of the present invention, the first body has on the second end face an essentially second planar circular ring surface, on the outer side of which a circumferential elevation is provided, wherein the second body has at a first end a flat circular ring surface, whose shape tolerance (also known as form tolerance), flatness or evenness, is in the range of 0.2 mm and whose internal diameter corresponds to or is greater than the diameter of the passage and whose external diameter corresponds to or is greater than the external diameter of the first body. The bodies are arranged in relation to one another in the assembled state such that they are in contact with one another in the area of the circumferential elevation and the flat circular ring surfaces and are welded to one another with a circumferential weld seam.

The formation of a circumferential elevation at a body and of a flat circular ring surface in this shape tolerance (flatness) range at the other body makes it possible to use very rapid welding methods, for example, capacitor discharge welding to produce the all-around gastight weld seam. Another great advantage of this welding method is that the sleeve will not be warped. Thus, the thread in the sleeve does not need to be either checked or finished, as this happens, for example, in the case of MAG (metal active gas) welding. As a result, the costs of the manufacture can be further reduced.

According to an advantageous variant of the present invention, the first body has on the second end face a section, at which the diameter of the first body is smaller than or equal to the diameter of the passage.

Due to this configuration, the above section protrudes in the assembled state into the second body. This makes possible a simplified mounting device, because the first body is centered in the second one during the preassembly. The manufacture of the probe socket can be simplified in this manner.

According to an advantageous variant of the present invention, the second body passes over into an essentially hollow cylindrically configured area following the flat circular ring surface, and the second end of the second body is configured such that a closing surface of the second end is located in a plane that is not parallel to the flat circular ring surface.

An adaptation of the probe socket to the housing geometry of the exhaust system is achieved due to this configuration with a very small, likewise hollow cylindrically configured component. For example, an adaptation to a chamfer of the housing can be compensated with a very thin disk, whose end faces are not plane-parallel to one another but have an angle in relation to one another.

According to an advantageous variant of the present invention, the second body passes over into an arched or partially cylindrically configured area following the flat circular ring surface.

The configuration of the end of the second body, which end is intended for the connection to the exhaust system, as an arched or partially cylindrical surface makes it possible to connect the probe socket to a plurality of types of exhaust systems having different configurations.

According to an advantageous variant of the present invention, the flat circular ring surface of the second body is finished with a planishing method.

Planishing is a method in which a pressure is applied to the component in a direction at right angles to the flat circular ring surface in order to prepare a flat surface in the necessary shape tolerance (flatness) by a slight deformation of the component. This is a very simple and rapid method, by which a further machining of the component is avoided and additional costs can thus be saved.

According to an advantageous variant of the present invention, the first body is made of steel as a turned part.

Rapid and favorable manufacture of the sleeve with a very close shape tolerance can be guaranteed by manufacturing the standard sleeve as a turned part.

According to an advantageous variant of the present invention, the second body is made from sheet metal as a deep-drawn part.

It is not necessary under certain conditions to manufacture the second body as a forged or sintered part. Due to the use of the even more favorable method of deep drawing, a further cost reduction can thus be achieved. The special socket can thus be adapted in a favorable manner to types of exhaust systems of nearly any desired shape.

According to an advantageous variant of the present invention, the special socket is manufactured such that a first body, which forms a hollow cylinder with planar circular ring surfaces at both ends, is manufactured first by turning from steel, and a circumferential elevation, which has a cross section in the form of an equilateral triangle, is formed at one of the circular ring surfaces. A second body is then manufactured as a sintered or forged component, and a circular ring surface with a shape tolerance (a flatness or maximum axial deviation of two points of the circular ring surface with respect to an axis surrounded by this ring surface) of 0.2 mm is prepared at one end of the second body by a planishing method. The first and second bodies are then arranged such that the circumferential elevation of the first body is in contact with the flat circular ring surface of the second body and connects the two bodies to one another by means of capacitor discharge welding.

Capacitor discharge welding is characterized by very short welding times with a local energy concentration and with a small heat influence zone in the components. As a result, thermal warping of the thread in the first body is avoided and the operations of checking the thread and the frequently necessary finishing operations are thus avoided. In addition, reliable welding of high-strength steels and greatly different material combinations, also welding partners with good conductivity in many different dimensions is made possible.

Further features and advantages of the present invention appear from the following description of exemplary embodiments of the present invention on the basis of the figures, which show features essential for the present invention, and from the claims. The individual features may be embodied individually or as a plurality of features in any desired combination in a variant of the present invention.

Some exemplary embodiments of the present invention are shown in the drawings and will be explained in more detail in the following description. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a sectional view of an embodiment of the probe socket;

FIG. 2 is a sectional view of another embodiment of the probe socket;

FIG. 3 is a sectional view of another embodiment of the probe socket;

FIG. 4 is a sectional view of the first body according to this embodiment; and

FIG. 5 is a sectional view of an embodiment of the second body.

### DESCRIPTION OF PREFERRED EMBODIMENTS

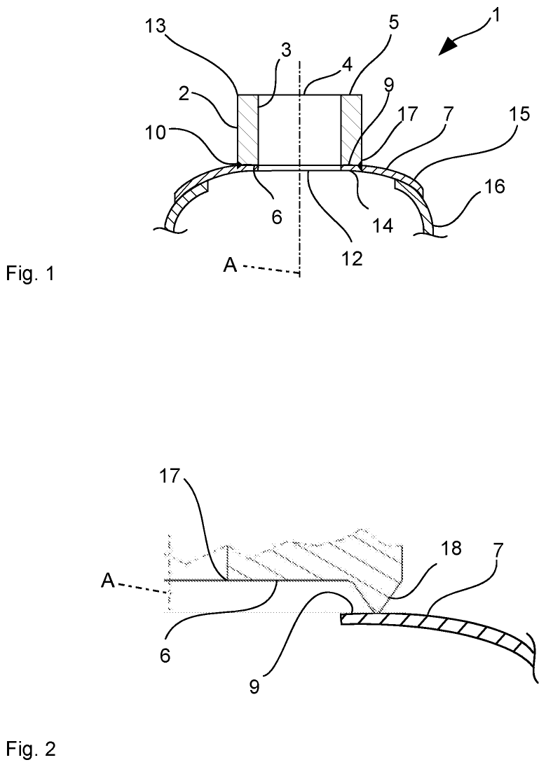

Referring to the drawings, the probe socket 1 shown in FIG. 1 has a first body 2 for receiving a measuring probe (not shown). The body 2 is manufactured as an essentially hollow cylindrical sleeve from a suitable material, e.g., steel. Since the probe must be fastened, on the one hand, securely at the first body 2, but it also must be able to be removed, on the other hand, in case of a defect, an internal thread is provided on the inner side 3 of the sleeve. The probe is screwed in the mounted state into the sleeve via an external thread provided on the probe. In order to prevent exhaust gases from escaping to the outside via the opening 4 of the sleeve, which opening faces away from the exhaust system, the opening 4 must be sealed gastightly against the probe. Gastight means in the sense of this invention that essentially no gas escapes from the opening into the surrounding area at the pressures usually prevailing in exhaust systems. A first planar circular ring surface 5 is provided for this purpose at the sleeve at the end of the sleeve facing away from the exhaust system in the mounted state. A planar circular ring surface is defined as a ring surface located in a plane, which has a shape tolerance of the plane (a flatness or maximum axial deviation of two points of the circular ring surface with respect to an axis surrounded by this ring surface) in the range of 0.2 mm. The sleeve may be manufactured, for example, as a turned part, the circular ring surface 5 being manufactured jointly with the necessary tolerance.

This circular ring surface 5 interacts in the assembled state with a sealing surface provided on the probe, and the sealing surfaces are pressed against one another by the screwing of the probe into the sleeve. A sealing ring may optionally be provided between the circular ring surface 5 and the sealing surface. Furthermore, a second planar circular ring surface 6 is provided at the sleeve at the end of the sleeve facing the exhaust system in the mounted state. The shape tolerance of this planar circular ring surface 6 (flatness) is likewise in the range of 0.2 mm. The maintenance of the shape tolerances (flatness) in this area makes possible, furthermore, in addition to a good possibility of sealing at one end of the sleeve, the use of different joining techniques at the other end of the sleeve, which would be able to be employed with a greater difficulty only if at all in case of coarser shape tolerances.

The probe socket 1 has, furthermore, a second body 7, via which the probe socket 1 is connected to the exhaust system. In the embodiment shown in FIG. 1, the second body 7 has at a first end 14 a flat circular ring surface 9, with which a passage 12 is provided for the measuring probe. In the assembled state, the first body 2 with the planar circular ring surface 6 is in contact with the flat circular ring surface 9. In the completely manufactured state, the bodies are connected to one another in a gastight manner in this area with a weld seam 10 extending circumferentially around the first body 2. A second end 15 of the second body 7 is configured in this embodiment as an arched free form, which is adapted to a likewise arched connection surface 16 of an exhaust system. Due to this embodiment of the second body 7, it is made possible to arrange the first body 2 manufactured as a standard component on any desired surfaces, which deviate in their geometry from the plane. Since the second body 7 with its second end 15 is flatly in contact with the connection surface 16, a gastight connection can be prepared between the second body 7 and the connection surface 16 in a simple manner, for example, by MAG welding or another widely used welding method.

In an especially advantageous embodiment, the first and second bodies are welded together by capacitor discharge welding, as a result of which a very short manufacturing time can be obtained. In addition, heat is introduced into only a very small area of the first body 2 over a very short time period. It is thus avoided that the internal thread would undergo deformation due to the introduction of heat on the inner side 3 of the sleeve. A subsequent checking and finishing of the internal thread, which would otherwise be necessary to ensure the dimensional stability and the functionality of the thread, is thus eliminated.

The probe socket 1 shown in FIG. 2, which is not yet welded, has some features that are especially advantageous for capacitor discharge welding. Thus, the first body 2 has, on the outer side of the second planar circular ring surface 6, a circumferential elevation 18, which has the cross section of an equilateral triangle prior to the welding. The triangle has an angle α₁ of about 70° at the apex. The angle α₂ between the outer wall of the first body 2 and the outer side of the triangle equals about 35°. The triangle preferably has a width b₂ of at most 0.2 mm at its apex before the welding. As a result, the contact surface, with which the first body 2 is in contact with the flat circular ring surface 9 of the second body 7 prior to the welding, will be very small. As a result, a high current density, which brings about heating and partial melting of the metal in this area, will be obtained in this area during the welding operation. The first body 2 and the second body 7 are pressed against one another prior to the welding operation, as a result of which the first body 2 will sink into the second body 7 by about 0.5 mm. The height h of the circumferential elevation 18 in the non-welded state, equaling about 1.5 mm, will thus decrease in the welded state to about 1 mm. A circumferential gastight connection of the two bodies is thus guaranteed. The second body 7 has a flat circular ring surface 9, which has a shape tolerance (flatness) of 0.2 mm. A uniform contact of the first body 2 on the second body 7 is guaranteed by this shape tolerance (flatness) prior to the welding. This is essential for capacitor discharge welding, because even very minor gaps may lead to an interruption of the weld seam. The flat circular ring surface 9 should still have a width b₁ of 2 mm within and outside a contact line L.

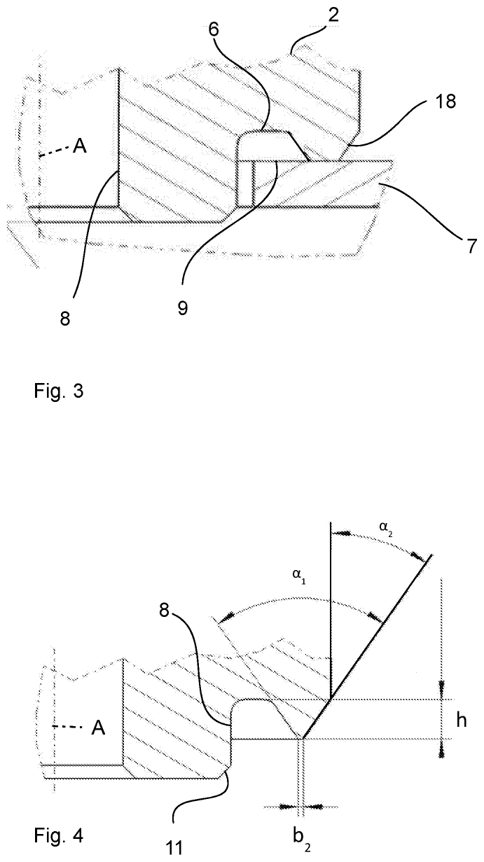

FIG. 3 shows a sectional view of a probe socket 1, which was manufactured by means of capacitor discharge welding. The second body 7 still has the flat circular ring surface 9 with the shape tolerance (flatness) of 0.2 mm. The first body 2 is connected with the circumferential elevation 18 arranged at the second planar circular ring surface 6 to the second body 7 by a weld seam. In the embodiment shown, the first body 2 has a section 8 whose diameter is smaller than the diameter of the passage 12, which protrudes into the passage 12. The first body 2 can be inserted due to this embodiment into the second body 7 prior to the welding. To facilitate the insertion, a chamfer 11 is provided on the first body 2. This embodiment makes it possible to simplify the mounting device with which the components are braced prior to the welding.

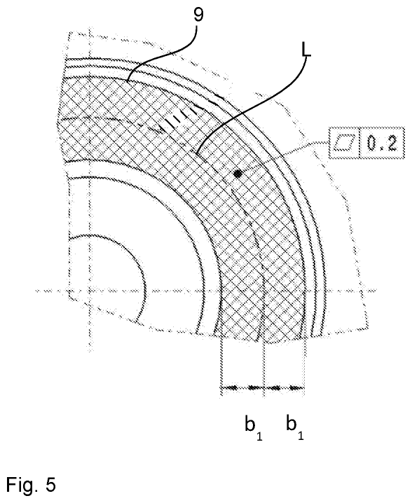

With reference to the above-mentioned shape tolerance, it should be pointed out that in the sense of the present invention the flatness e.g. of the circular ring surface 9 is schematically represented in FIG. 5. With a shape tolerance or flatness of 0.2 mm or in the range of 0.2 mm, the flatness can thus be expressed as a maximum axial deviation or a maximum axial offset of two points on the surface under consideration, for example the circular ring surface 9, to each other in the direction of an axis surrounded by the circular ring surface (the axis A shown as a dash-dot line in FIGS. 1 to 4) that does not exceed a value of about 0.2 mm.

FIG. 4 shows a first body 2 of this embodiment prior to the welding, in which the circumferential elevation 18 is shown in the undeformed state.

FIG. 5 shows a view of the second body 7 prior to the welding and especially the flat circular ring surface 9.

Even though certain elements, embodiments and applications of the present invention are shown and described, it is apparent that the present invention is not limited to these and the person skilled in the art may make modifications without deviating from the range of validity of the present disclosure, especially in view to the above teachings.

While specific embodiments of the invention have been shown and described in detail to illustrate the application of the principles of the invention, it will be understood that the invention may be embodied otherwise without departing from such principles.

### LIST OF REFERENCE NUMBERS

1 Probe socket
2 First body
3 Inner side of the sleeve
4 Opening
5 First planar circular ring surface
6 Second planar circular ring surface
7 Second body
8 Section
9 Flat circular ring surface
10 Weld seam
11 Chamfer
12 Passage
13 First end face
14 First end
15 Second end
16 Connection surface
17 Second end face
18 Circumferential elevation

What is claimed is:

1. An exhaust system probe socket comprising:
an essentially hollow cylindrically configured first body which has a first planar circular ring surface on a first end face with an first body internal diameter; and
a second body, which has a flat circular ring surface at a first end, has a second end and within the flat circular ring surface has a passage with a second body internal diameter, wherein:
the second body internal diameter corresponds to or is greater than the first body internal diameter;
the second end of the second body is configured to form a gastight connection of the probe socket to a connection surface by compensating geometric deviations of the connection surface from a plane; and
the first and second bodies are in contact with one another in an area of a second end face of the first body and of the flat circular ring surface and are welded to one another with a weld seam extending circumferentially around the first body such that the first and second bodies are gastight connected to one another.

2. An exhaust system probe socket in accordance with claim 1, wherein:
the second end face of the first body has an essentially second planar circular ring surface with an outer side with a circumferential elevation;
the first end of the second body has a flat circular ring surface with a flatness of 0.2 mm with an internal diameter that corresponds to or is greater than the second body internal diameter;
the second body has an external diameter that corresponds to or is greater than an external diameter of the first body; and
the first and second bodies are arranged in relation to one another in the assembled state such that the first and second bodies are in contact with one another in an area of the circumferential elevation and of the flat circular ring surfaces and are welded together with the circumferential weld seam.

3. An exhaust system probe socket in accordance with claim 1, wherein the second end face of the first body has a section at which first body internal diameter is smaller than or equal to the second body internal diameter.

4. An exhaust system probe socket in accordance with claim 3, wherein the section protrudes into the passage of the second body.

5. An exhaust system probe socket in accordance with claim 1, wherein:
the second body passes over following the flat circular ring surface into an essentially hollow cylindrically configured area; and
the second end of the second body is configured such that a closing surface of the second end is located in a plane that is not parallel to the flat circular ring surface.

6. An exhaust system probe socket in accordance with claim 1, wherein the second body passes over following the flat circular ring surface into an arched or partially cylindrically configured area.

7. An exhaust system probe socket in accordance with claim 1, wherein the flat circular ring surface of the second body is finished with a planishing process.

8. An exhaust system probe socket in accordance with claim 1, wherein the first body is configured as a turned part consisting of steel.

9. An exhaust system probe socket in accordance with claim 1, wherein the second body is configured as a deep-drawn part consisting of sheet metal.

10. A process for manufacturing an exhaust system probe socket, the process comprising the steps of:
forming an essentially hollow cylindrically configured first body which has a first planar circular ring surface on a first end face with an first body internal diameter;
forming a second body, which has a flat circular ring surface at a first end, has a second end and within the flat circular ring surface has a passage with a second body internal diameter;
providing the second body with an internal diameter that corresponds to or is greater than the first body internal diameter;
configuring the second end of the second body to form a gastight connection of the probe socket to a connection surface by compensating geometric deviations of the connection surface from a plane;
placing the first body and the second body in contact with one another in an area of a second end face of the first body and of the flat circular ring surface; and
welding the contacting first body and the second body to one another with a weld seam extending circumferentially around the first body such that the first and second bodies are gastight connected to one another.

11. A process according to claim 10, wherein:
the first body is turned from steel, which forms the hollow cylinder with planar circular ring surfaces at both ends, wherein a circumferential elevation, which has a shape of an equilateral triangle in cross section, is formed on one of the circular ring surfaces;
the second body is prepared as a sintered or forged component;
the circular ring surface of the second body as a shape tolerance of 0.2 mm prepared by a planishing method at the first end;
the first and second bodies are arranged such that the circumferential elevation is in contact with the flat circular ring surface of the second body; and
the first and second bodies are welded to one another by means of capacitor discharge welding.

12. A process in accordance with claim 11, wherein the second end face of the first body has a section at which first body internal diameter is smaller than or equal to the second body internal diameter.

13. A process in accordance with claim 12, wherein the section protrudes into the passage of the second body.

14. A process in accordance with claim 11, wherein:
the second body passes over following the flat circular ring surface into an essentially hollow cylindrically configured area; and
the second end of the second body is configured such that a closing surface of the second end is located in a plane that is not parallel to the flat circular ring surface.

15. A process in accordance with claim 11, wherein the second body passes over following the flat circular ring surface into an arched or partially cylindrically configured area.

16. A process in accordance with claim 10, wherein the flat circular ring surface of the second body is finished with a planishing process.

17. A process in accordance with claim 10, wherein the first body is configured as a turned part consisting of steel.

18. A process in accordance with claim 10, wherein the second body is configured as a deep-drawn part consisting of sheet metal.
